(19) United States
(12) Patent Application Publication
(10) Pub. No.: US 2008/0264760 A1
(43) Pub. Date: Oct. 30, 2008

(54) VIBRATORY FEEDER

(76) Inventors: Josef Bentele, Laupheim (DE); Georg Pfau, Laupheim (DE)

Correspondence Address: K.F. ROSS P.C., 5683 RIVERDALE AVENUE, SUITE 203 BOX 900, BRONX, NY, 10471-0900, US

(21) Appl. No.: 12/107,193

(22) Filed: Apr. 22, 2008

(30) Foreign Application Priority Data
Apr. 25, 2007 (EP) 07008415.7

(51) Int. Cl. B65G 47/12; B65G 11/00; B65G 27/00; B65G 47/26

(52) U.S. Cl. 198/453; 193/2 R

(57) ABSTRACT

A vibratory feeder has a generally horizontal disk centered on an upright axis and extending angularly from an intake to a downwardly open outlet. A linear guide forms a plurality of straight tracks extending substantially parallel to one another upstream in the direction from the outlet. A multiplicity of small objects are deposited onto the disk at the intake, and the disk is angularly oscillated to transport the objects in a travel direction from the intake to the linear guide and thence in straight lines along the tracks into the outlet.

### FIELD OF THE INVENTION

The present invention relates to a vibratory feeder. More particularly this invention concerns such a feeder that moves unsorted small objects from an input location to an offset output location while aligning the objects in rows.

### BACKGROUND OF THE INVENTION

In order to package small objects such as pills or capsules, the objects are typically dumped at an input location on a generally horizontal and circular feed disk that is centered on an upright axis and that is angularly oscillated so as to advance the objects angularly to an output location offset from the input location. From the output the objects are typically loaded into individual respective blisters of blister packs that are then closed and further packaged. The circular disk serves as a coupling element between the supply where the objects are held in bulk and a transfer means that feeds them one at a time to the blister packages. The objects are transported circumferentially or angularly from the input to the output by an oscillating motion of the circular vibration disk.

The problem with this is the sorting tracks of the circular vibration disk extend along respective concentric circular arcs. Thus the objects move at different speeds, depending on the radial position, and the conveying capacity of the vibration disk varies with the radial spacing of the sorting tracks from the disk center. As a result, the conveying capacity of the inner conveyors is reduced by up to 30%. Hence the system has to work based on the speed of the objects arriving most slowly, and the objects traveling more rapidly are backed up.

### OBJECTS OF THE INVENTION

It is therefore an object of the present invention to provide an improved vibratory feeder.

Another object is the provision of such an improved vibratory feeder that overcomes the above-given disadvantages, in particular that ensures that the objects are all fed at the same speed to the outlet

The object of the invention is to design a vibratory feed as mentioned above in a way, such that the performance thereof can be increased.

### SUMMARY OF THE INVENTION

A vibratory feeder has according to the invention a generally horizontal disk centered on an upright axis and extending angularly from an intake to a downwardly open outlet. A linear guide forms a plurality of straight tracks extending substantially parallel to one another upstream in the direction from the outlet. A multiplicity of small objects are deposited onto the disk at the intake, and the disk is angularly oscillated to transport the objects in a travel direction from the intake to the linear guide and thence in straight lines along the tracks into the outlet.

The advantage with this design is that the circular vibration disk is only used as a presorter and an even feed of the objects, independent from the radial position thereof, is achieved in the linear sorter.

According to the invention the linear sorter is provided in a radial cutout of the circular vibration disk, in order to keep the height level for conveying the objects constant.

It is particularly preferable, when the linear sorter has its own drive for a longitudinal vibration in the direction of a tangent to the circular vibration disk, in order to achieve active conveying of the objects also on the linear sorter and to prevent the objects from having to be pushed forward by the following objects.

For creating the longitudinal vibration, it has proven advantageous for the drive to be a piezo or magnetic drive, as it reduces the required amplitudes of oscillation for the deflection.

For trouble-free feeding of the objects into the linear sorter, the linear sorter is shaped at its radially inner edge to conform to the curvature of the hub of the circular vibration disk.

Uniform conveying while guaranteeing the order of the objects is improved when the linear sorter has upstanding walls extending mainly in straight lines parallel to the travel direction for the objects.

For better feed of the objects in the linear sorter, the hub has a guidance bulge upstream of the linear sorter and serving to correctly orient of the objects before entering the tracks formed by the walls.

Alternatively, the possibility exists to design at least the upstream end of the radial innermost wall to be curved radially inward, in order to compensate for the extreme curvature and to facilitate the feed of the respective objects. All the walls can be curved in this manner.

Good sorting on the circular vibration disk is achieved when the outlet is spaced angularly at least 180°, preferably 270° from the intake where the objects are deposited at random on the disk.

A particularly preferred embodiment of the invention is characterized by the linear sorter whose upper surface is angled in the travel direction. A further increase of the output efficiency is achieved by the design, as the amplitude of oscillation of the linear sorter is reduced with a certain conveying capacity. It has proven advantageous, for the angle to be between 2° and 20°, preferably between 5° and 10°.

To omit disturbances during the transfer of the objects from the outlet, the outlet is provided with deflecting roller for the transfer of the objects to a feeding chute.

### BRIEF DESCRIPTION OF THE DRAWING

The above and other objects, features, and advantages will become more readily apparent from the following description, reference being made to the accompanying drawing in which:

FIG. 1 is a side sectional view through the feeder according to the invention;

FIG. 2 is a top view of the feeder;

FIG. 3 is a top view of an alternative feeder; and

FIG. 4 is a vertical section through a detail of the feeder.

### SPECIFIC DESCRIPTION

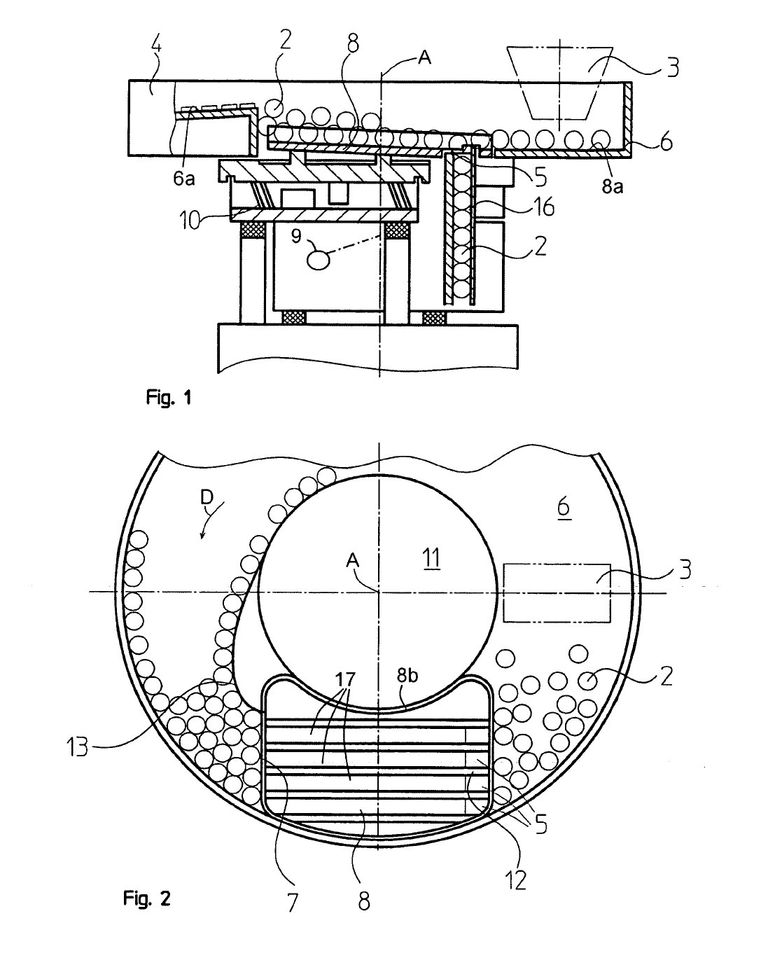

As seen in FIG. 1, a vibratory feed 1 for the feed of objects 2, for example pharmaceuticals in the form of pills, capsules or the like has an intake or supply means 3 where the objects 2 are loaded onto a circular vibration disk 6, oscillating angularly and driven by a central drive and transporting the objects 2 to an outlet 5 offset angularly in a travel direction D by about 270°. An axially thoroughgoing and radially outwardly open cutout 7 of the disk 6 receives a linear sorter 8 immediately upstream of the outlet 5. A drive 10, here a piezo drive, operates the linear sorter 8 for a longitudinal vibration in the direction of a branch of the circular vibration disk 6. A magnetic drive could also be used. The disk 6 has an upper face 6a shaped as a spiral that rises gently in the transport direction D and the sorter 8 has a basically planar upper face 8a that descends in the direction D at an angle between 2° and 20°, preferably between 5° and 10°. The drives 9 and 10 displace the respective surfaces 8a and 6a simultaneously upward and downstream, then simultaneously downward and upstream so as to shift the objects 2 downstream.

As a result, the objects 2 do not have to run on sorting conveyors with different circular arcs before the outlet 5, but are guided in parallel during the last section of the conveying route.

As seen in FIG. 2, the linear sorter 8 is shaped at its radial internal edge 8b to the curvature of a cylindrical center hub 11 of the disk 6. The linear sorter 8 has walls 12 running parallel to each other and tangentially of the axis A to form tracks 17 that sort the objects 2 into parallel one-deep rows. The hub 11 has an rounded radially outwardly projecting bump 13 upstream of the linear sorter 8 that pushes the objects 2 into upstream ends of the individual tracks 17. From the downstream ends of the tracks 17 the objects 2 drop on at a time into the outlet 5.

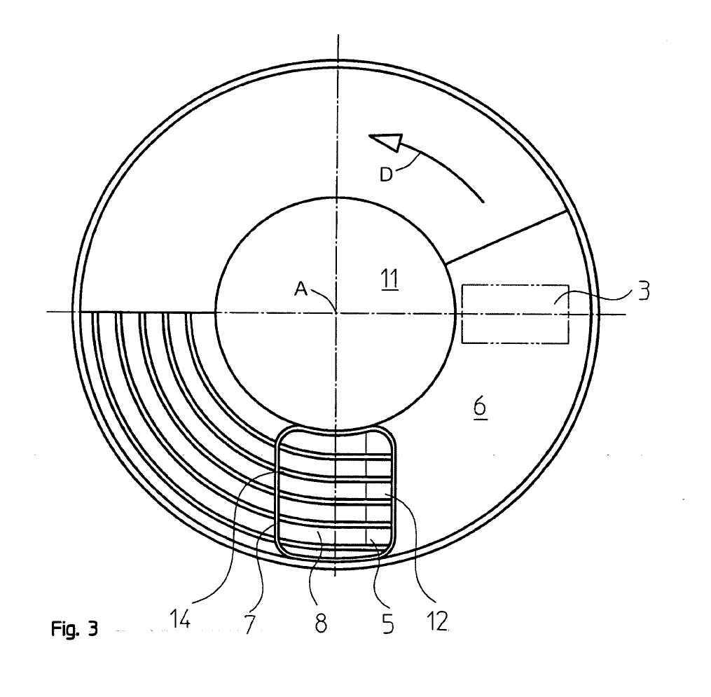

According to FIG. 3, entry of the objects 2 into the tracks 17 can be facilitated by curving the upstream inlet portions 14 of the at least the radial innermost wall 12 (here all the walls 12) being radially inward. Thus these portions 14 have radii of curvature centered on the axis A so that the objects enter them while moving angularly but then are sorted into straight-line travel.

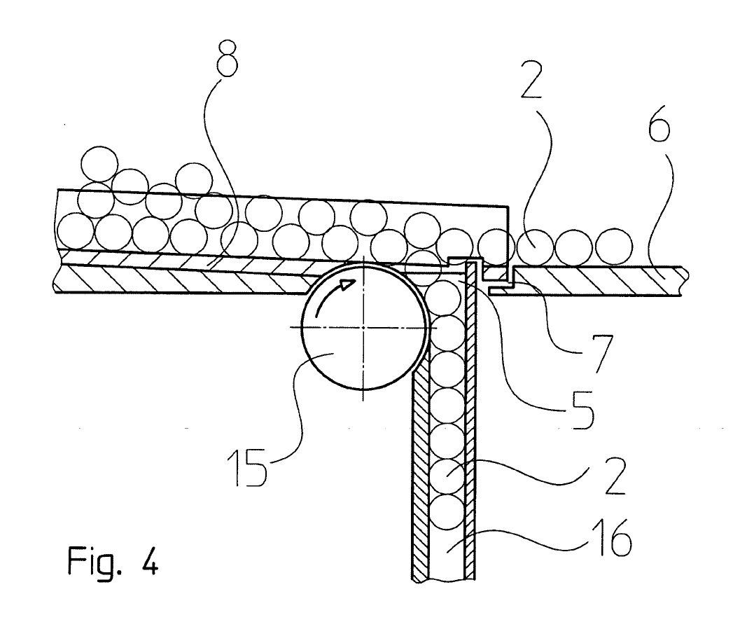

FIG. 4 shows a deflecting roller 15 immediately upstream of the outlet 5. It rotates about a radially extending axis to transfer of the objects 2 into a feed chutes 16 of the outlet, rotating so that its upper surface moves in the travel direction D.

We claim:

1. A vibratory feeder comprising:
a generally horizontal disk centered on an upright axis and extending angularly from an intake to a downwardly open outlet;
a linear guide forming a plurality of straight tracks extending substantially parallel to one another upstream in the direction from the outlet;
means for depositing a multiplicity of small objects on the disk at the intake; and
means for angularly oscillating the disk and thereby transporting the objects angularly of the axis in a travel direction from the intake to the linear guide and thence in straight lines along the tracks into the outlet.

2. The feeder defined in claim 1 wherein the disk is formed upstream of the outlet with a cutout, the linear guide fitting in the cutout and having an upper surface forming an extension of an upper face of the disk.

3. The feeder defined in claim 2, further comprising
means for vibrating the linear guide generally parallel to the tracks for moving the objects along the tracks in straight lines to the outlet.

4. The feeder defined in claim 3 wherein the means for vibrating the linear guide is a piezoelectric or magnetic vibrator.

5. The feeder defined in claim 1 wherein the disk has a central axially upstanding hub and the linear guide fits complementarily against the hub.

6. The feeder defined in claim 5 wherein the hub is substantially cylindrical and centered on the axis and the guide has a circularly concave inner edge.

7. The feeder defined in claim 5 wherein the hub is provided with a radially outwardly projecting bump that deflects the objects radially outward to the linear guide.

8. The feeder defined in claim 1 wherein the tracks are formed as upwardly open straight grooves.

9. The feeder defined in claim 1 wherein the tracks are each defined by a pair of upright walls that extend straight and parallel to each other at least in the vicinity of the outlet.

10. The feeder defined in claim 9 wherein at least some of the walls have upstream ends curved arcuately inward and having radii of curvature centered substantially on the axis.

11. The feeder defined in claim 1 wherein the intake and output are spaced apart angularly by at least 180°.

12. The feeder defined in claim 1 wherein the linear sorter has an upper surface angled downward in the travel direction.

13. The feeder defined in claim 12 wherein the upper surface is angled downward by between 2° and 20°.

14. The feeder defined in claim 1, further comprising
a rotatable feed roller immediately upstream of the outlet and downstream of the linear guide; and
means for rotating the roller such that it advances the objects from downstream ends of the tracks of the linear feeder to the outlet.

15. The feeder defined in claim 1, further comprising
an outlet chute opening upward immediately downstream of the linear guide at the outlet.
